(19) United States
(12) Patent Application Publication
(10) Pub. No.: US 2006/0200994 A1
(43) Pub. Date: Sep. 14, 2006

(54) Multi-purpose cooking utensil

(76) Inventor: Brett Di Paolo, Brampton (CA)

Correspondence Address: GEORGE A. ROLSTON, 45 SHEPPARD AVE EAST, SUITE 900, TORONTO, ON, M2N5W9, CA

(21) Appl. No.: 11/371,091

(22) Filed: Mar. 9, 2006

Related U.S. Application Data
(60) Provisional application No. 60/659,417, filed on Mar. 9, 2005.

(51) Int. Cl. B26B 11/00

(52) U.S. Cl. 30/142

(57) ABSTRACT

A multi-purpose cooking utensil including an elongate handle member having a first end and an opposite second end, and a generally flat spatula member provided on the second end of the elongate handle member, the spatula member having a first side edge generally opposed to a second side edge, wherein the first side edge having a cutting means, and wherein the second side edge having a tenderizing means.

### PRIOR APPLICATION

This application claims the benefit of U.S. Provisional Application Ser. No. 60/659,417, filed Mar. 9, 2005, entitled BIG FLIPPER.

### FIELD OF THE INVENTION

The invention relates to cooking utensils, and more particularly to a multi-purpose cooking utensil.

### BACKGROUND OF THE INVENTION

Outdoor barbequing is an increasingly popular cooking technique which produces foods, such as steaks, chicken and vegetables, having unique flavors and textures which cannot be easily duplicated in a traditional kitchen. During the preparation of a meal which involves the searing and grilling of food on a barbeque, the barbeque user often must use several cooking utensils to tenderize, slice and reposition the food on the barbeque grill. Most barbeque users have at least a half dozen individual cooking utensils that they regularly use when barbequing. Given that there is limited space on barbeques to store these utensils, it often occurs that the barbeque user must step away from the barbeque to locate the appropriate utensil(s) for each of these purposes. During which time the foods may become adhered to the grill and/or burn as a result of the intense flame of the barbeque. Moreover, the use of individual cooking utensils may result in the barbeque user accidentally burning their hand, wrist or arm on the barbeque when searching for the appropriate utensil. Dropping one or more of these individual utensils may also result in considerable damage to the cooking surface of the barbeque grills and the heating element within the barbeque.

Accordingly, there is a need for a multi-purpose cooking utensil for use when barbequing consisting of a spatula member provided on an elongate handle member, the spatula member have cutting means and tenderizing means. There is a further need for a multi-purpose cooking utensil having an elongate handle member that maintains the barbeque user's hands and wrists at a safe distance form the grill when barbequing.

### SUMMARY OF THE INVENTION

The present invention is directed to a multi-purpose cooking utensil including an elongate handle member having a first end and an opposite second end, and a generally flat spatula member provided on the second end of the elongate handle member, the spatula member having a first side edge generally opposed to a second side edge, wherein the first side edge having a cutting means, and wherein the second side edge having a tenderizing means. The cutting means and the tenderizing means are integrally formed with the spatula member. The cutting means including a blade extending generally along the first side edge of the spatula member. The tenderizing means including a plurality of teeth extending from the second side edge of the spatula member.

The first end of the elongate handle member is provided with a heat-resistant sleeve. The first end of the elongate handle member is provided with a hook means. The elongate handle member and the spatula member are made of a metallic material or polypropylene. The first end of the elongate handle member may be disposed in an offset alignment to the second end thereof.

The present invention is also directed to a multi-purpose cooking utensil including a spatula member having a third side edge generally perpendicular to the first and second side edges, and wherein the third side edge is provided with a cutting means. The third side edge of the spatula member may have a third side edge generally perpendicular to the first and second side edges, and wherein the third side edge having a tenderizing means.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a perspective view of a multi-purpose cooking utensil made in accordance with a preferred embodiment of the invention;

FIG. 2 is a perspective view of the spatula member of the multi-purpose cooking utensil of FIG. 1;

FIG. 3 is a side elevation view of the multi-purpose cooking utensil of FIG. 1; and

FIG. 4 is top plan view of the multi-purpose cooking utensil of FIG. 1.

### DETAILED DESCRIPTION OF THE INVENTION

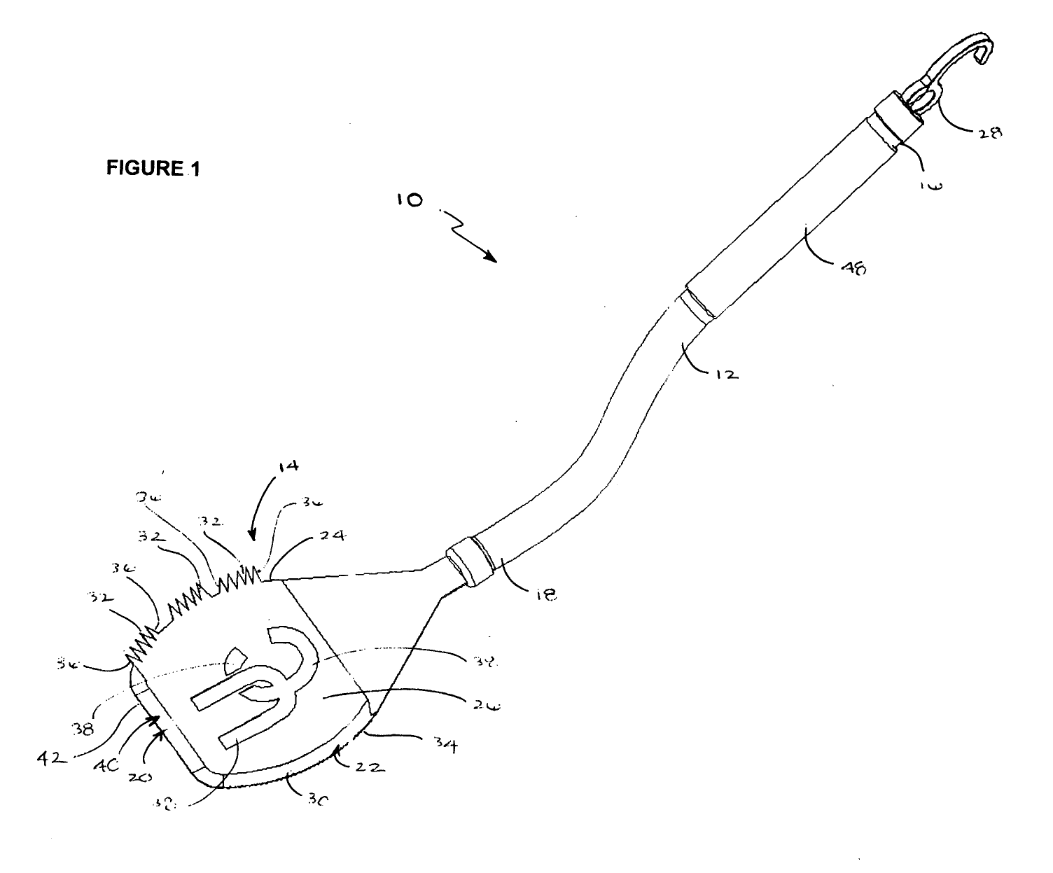

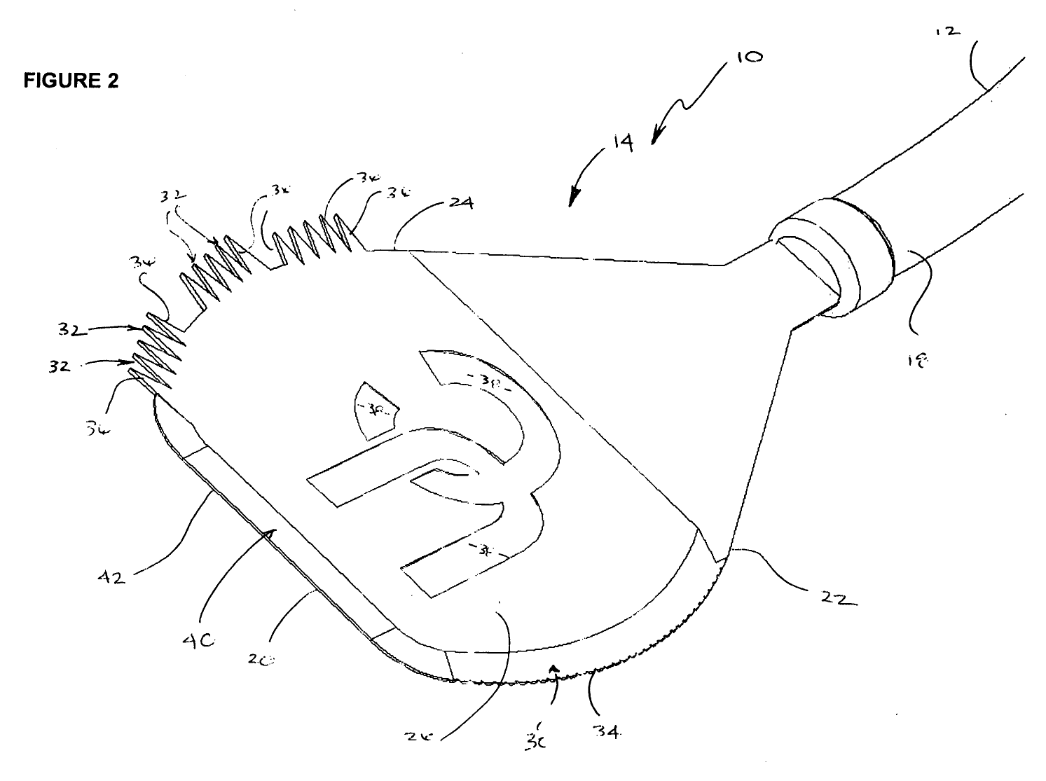

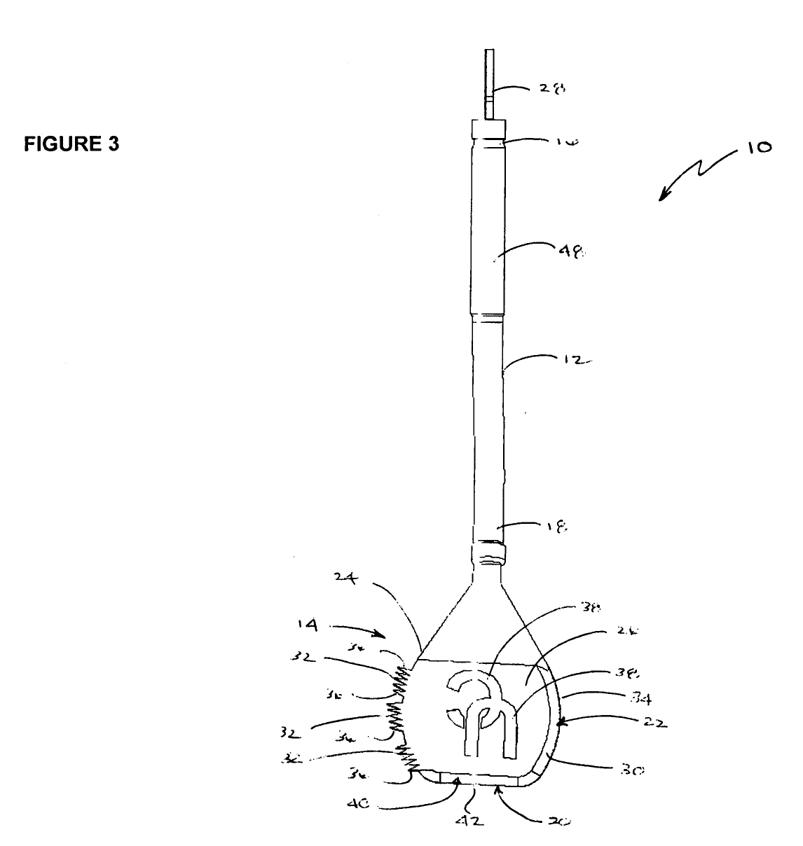

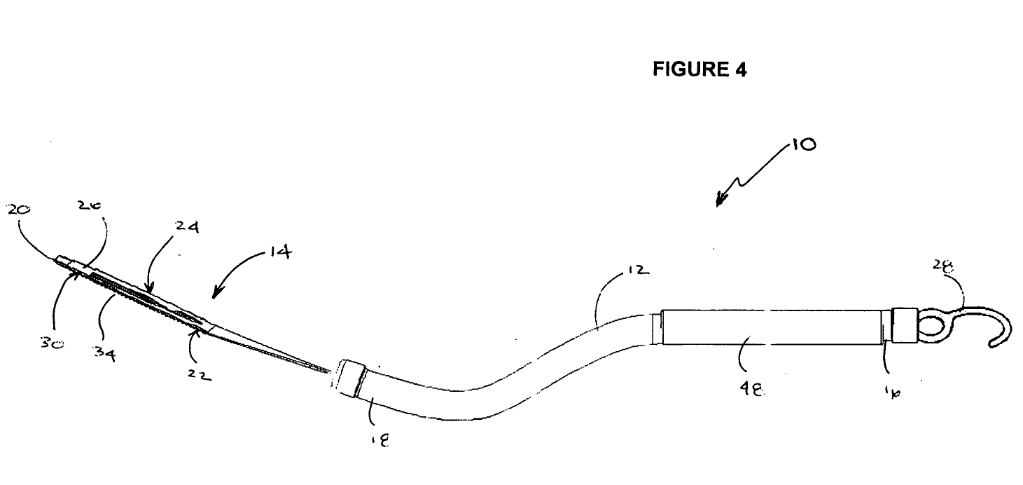

Reference is made to FIGS. 1, 2, 3 and 4 which illustrate a multi-purpose cooking utensil 10 for use when barbequing made in accordance with a preferred embodiment of the present invention. Cooking utensil 10 has an elongate handle member 12 and a generally flat spatula member 14. The elongate handle member 12 having a first end 16 and an opposite second end 18. The generally flat spatula member 14 is provided on the second end 16 of the elongate handle member 12, and includes a front edge 20, a first side edge 22, and a second side edge 24 generally opposed to the first side edge 22. The front edge 20, the first side edge 22, and the second side edge 24 generally defines a food support surface 26. The first end 16 of the elongate handle member 12 may have an optional hook means 28 to allow the cooking utensil 10 to be attached to a barbeque or the barbeque user's belt.

In the preferred embodiment of the present invention shown in FIGS. 1, 2, 3 and 4, the first side edge 22 of the spatula member 14 is formed with a cutting means 30, and the second side edge 24 is formed with a tenderizing means 32. The cutting means 30 and tenderizing means 32 may be integrally formed with the spatula member 14. The cutting means 30 has a sharp blade 34 that extends generally along the first side edge 22 of the spatula member 14, the blade 34 being adapted to slice and cut foods cooking on the barbeque. For example, the blade 34 of the cutting means 30 may be used by the barbeque user to slice off a portion of the food for sampling purposes and/or to ascertain whether the food has been properly cooked. The tenderizing means 32 has a plurality of sharp teeth 36 that extend from and generally along the second side edge 24 of the spatula member 14. The teeth 36 are generally triangular-shaped and are adapted to pierce and tenderize at least a surface portion of the food. The teeth 36 of the tenderizing means 32 may also be used by the barbeque user to puncture holes in the surface of foods, such as sausages and wieners, so as to allow the juices to escape and the seasonings to permeate the food. Additionally, the teeth 36 of the tenderizing means 32 are adapted to enable the barbeque user to use the multi-purpose cooking utensil 10 to engage and drag the food on the grill of the barbeque.

The front edge 20 of the spatula member 14 is generally perpendicular to the side edges 22 and 24, and is designed to be easily inserted beneath one or more of the foods cooking on a barbeque grill. The food support surface 26 may be formed with one or more apertures 38 that permit the flow through of juices or other liquids from the food when support above the spatula member 14. It should be understood that the one or more apertures 38 may have any suitable shape and/or configuration on the food support surface 26 as is known in the art. In a further embodiment of the present invention, the front edge 20 of the spatula member 14 may be formed with a front cutting means 40 having a front blade 42. The cutting means 40 may have a similar construction as the cutting means 30 on the first side edge 22 of the spatula member 14. It should be understood that either of the blade 34 and the front blade 42 may have serrated surfaces (not shown) for enhancing the slicing and cutting characteristics of the multi-purpose cooking utensil 10 of the present invention.

In a further embodiment of the present invention, the front edge 20 of the spatula member 13 may be formed with a front tenderizing means 44 having a plurality of front teeth 46 extending therefrom. The front tenderizing means 44 may have a similar construction as the tenderizing means 32 extending from the second side edge 24. Alternatively, the spacing, shape and/or configuration of the front teeth 46 on the front tenderizing means 44 may be different from the teeth 36 of the tenderizing means 32 so as to provide the barbeque user with a different means for tenderizing the food on the barbeque grill.

In a further embodiment of the present invention, the first end 16 of the elongate handle member 12 may be provided with a heat-resistant sleeve 48 to minimize the transmission of heat from the multi-purpose cooking utensil 10 to the hand of the barbeque user. The heat-resistant sleeve 48 may be made of any suitable material, such as, for example, rubber or polypropylene. It should be understood that the elongate handle member 12 and the spatula member 14 may be manufactured from any suitable material known by persons skilled in the art. For example, the elongate handle member 12 and the spatula member 14 may be manufactured from a metallic material, such as stainless steel or any steel material that may be appropriately formed and used a cutting means and/or tenderizing means. It should be understood that the length of the elongate handle member 12 should be sufficient to ensure that the hands and arms of the barbeque user are a safe distance away from the barbeque. Moreover, the first end 16 of the elongate handle member may be disposed in an offset alignment to the second end 18 thereof to further distance the hands and arms of the barbeque user from the hot surface of the barbeque grill.

The present invention has been described with regard to specific embodiments. However, it will obvious to persons skilled in the art that a number of variants and modifications can be made without departing from the scope and spirit of the invention, the scope of which is defined in the appended claims.

1. A multi-purpose cooking utensil, the cooking utensil comprising:
an elongate handle member having a first end and an opposite second end; and
a generally flat spatula member provided on the second end of the elongate handle member, the spatula member having a first side edge generally opposed to a second side edge, wherein the first side edge having a cutting means, and wherein the second side edge having a tenderizing means.

2. The multi-purpose cooking utensil as claimed in claim 1, wherein the cutting means and the tenderizing means are integrally formed with the spatula member.

3. The multi-purpose cooking utensil as claimed in claim 1, wherein the cutting means includes a blade extending generally along the first side edge of the spatula member.

4. The multi-purpose cooking utensil as claimed in claim 1, wherein the tenderizing means includes a plurality of teeth extending from the second side edge of the spatula member.

5. The multi-purpose cooking utensil as claimed in claim 1, wherein the spatula member having a third side edge generally perpendicular to the first and second side edges, and wherein the front edge having a cutting means.

6. The multi-purpose cooking utensil as claimed in claim 1, wherein the spatula member having a third side edge generally perpendicular to the first and second side edges, and wherein the front edge having a tenderizing means.

7. The multi-purpose cooking utensil as claimed in claim 1, wherein the first end of the elongate handle member is provided with a heat-resistant sleeve.

8. The multi-purpose cooking utensil as claimed in claim 1, wherein the handle member and the spatula member are made of a metallic material.

9. The multi-purpose cooking utensil as claimed in claim 1, wherein the handle member and the spatula member are made of polypropylene.

10. The multi-purpose cooking utensil as claimed in claim 1, wherein the first end of the elongate handle member is provide with a hook means.

11. The multi-purpose cooking utensil as claimed in claim 1, wherein the first end of the elongate handle member is disposed in an offset alignment to the second end thereof.
